(19) United States
(12) Patent Application Publication
(10) Pub. No.: US 2019/0033137 A1
(43) Pub. Date: Jan. 31, 2019

(54) IN-SITU EVALUATION OF CURING OF INK COMPOSITIONS VIA FLUORESCENCE SPECTROSCOPY AND RELATED METHODS

(71) Applicant: Xerox Corporation, Norwalk, CT (US)

(72) Inventors: Mandakini Kanungo, Penfield, NY (US); Jack T. LeStrange, Macedon, NY (US); Peter Knausdorf, Henrietta, NY (US); Xin Yang, Webster, NY (US); Anthony S. Condello, Webster, NY (US)

(73) Assignee: Xerox Corporation

(21) Appl. No.: 15/662,644

(22) Filed: Jul. 28, 2017

(51) Int. Cl. G01J 3/46; G01N 21/64; C09D 11/30; B41M 5/00

(52) U.S. Cl. CPC G01J 3/46; G01N 21/6428; G01N 2021/6439; B41M 5/0017; G01J 2003/468; C09D 11/30

(57) ABSTRACT

A method for evaluating curing in an ink composition comprises depositing an ink composition on the surface of an object via a direct-to-object inkjet printing system to form a film thereon, the ink composition comprising a photoinitiator capable of initiating a free radical polymerization process in the ink composition upon the absorption of light to cure the deposited film and a fluorophore capable of emitting viscosity-dependent fluorescence upon the absorption of light; exposing, in-situ, the deposited film to light generated by a first source of light under conditions which initiate the free radical polymerization process to cure the deposited film; exposing the cured film to light generated by a second source of light under conditions which induce fluorescence emission by the fluorophore in the cured film; measuring the fluorescence emission; and determining a degree of cure in the cured film from the measured fluorescence emission and predetermined calibration data.

### BACKGROUND

A variety of techniques have been used to evaluate the degree of cure in ink compositions. Such techniques include applying a solvent wipe to the surface of a cured film formed after depositing the ink composition. Visual inspection of the solvent wipe for removed material provides a qualitative measure of the degree of cure. Fourier-Transform Infrared Spectroscopy (FTIR) is another technique which may be used to quantitatively evaluate the degree of cure in the surface of the cured film via chemical fingerprints associated with the components of the uncured ink composition (e.g., carbon-carbon double bonds in unreacted monomers). Solvent extraction is another technique which may be used to quantitatively evaluate the degree of cure in the cured film. In this technique, the cured film is exposed to a solvent and the amount of material dissolved in the solvent measured and compared to that obtained from a fully cured film. Gas Chromatography/Mass Spectrometry (GC/MS) may be added to identify the dissolved material (e.g., unreacted monomers).

### SUMMARY

The present disclosure, which enables a quantitative, efficient measurement of the degree of cure of an ink composition without having to handle or destroy the cured film, accordingly provides illustrative examples of methods and systems for evaluating, in-situ, the degree of cure of ink compositions. Methods and systems for monitoring system components, including for initiating preventative maintenance are also provided.

In one aspect, methods for evaluating curing in an ink composition are provided. In embodiments, the method comprises depositing an ink composition on the surface of an object via a direct-to-object inkjet printing system to form a film thereon, the ink composition comprising a photoinitiator capable of initiating a free radical polymerization process in the ink composition upon the absorption of light to cure the deposited film and a fluorophore capable of emitting viscosity-dependent fluorescence upon the absorption of light; exposing, in-situ, the deposited film to light generated by a first source of light under conditions which initiate the free radical polymerization process to cure the deposited film; exposing the cured film to light generated by a second source of light under conditions which induce fluorescence emission by the fluorophore in the cured film; measuring the fluorescence emission; and determining a degree of cure in the cured film from the measured fluorescence emission and predetermined calibration data.

In another aspect, direct-to-object printing systems are provided. In embodiments, the direct-to-object printing system comprises an array of printheads, the array comprising one printhead configured to eject an ink composition and one or more additional printheads configured to eject one or more additional ink compositions; a support member positioned parallel to the array of printheads; an object holder configured to hold an object such that the surface of the object faces towards the array of printheads, the object holder moveably mounted to the support member; a first source of light; a second source of light; an actuator operatively connected to the object holder to move the object holder relative to the array of printheads, the first source of light, and second source of light; and a controller operatively connected to the array of printheads, the actuator, the first source of light, and the second source of light. The controller is configured to operate the direct-to-object printing system to deposit the ink composition on the surface of the object to form a film thereon, the ink composition comprising a photoinitiator capable of initiating a free radical polymerization process in the ink composition upon the absorption of light to cure the deposited film and a fluorophore capable of emitting viscosity-dependent fluorescence upon the absorption of light; expose, in-situ, the deposited film to light generated by the first source of light under conditions which initiate the free radical polymerization process to cure the deposited film; expose, in-situ, the cured film to light generated by the second source of light under conditions which induce fluorescence emission by the fluorophore in the cured film; measure the fluorescence emission; and determine a degree of cure in the cured film from the measured fluorescence and predetermined calibration data.

### BRIEF DESCRIPTION OF THE DRAWINGS

Illustrative embodiments will hereafter be described with reference to the accompanying drawings.

FIG. 1A depicts a schematic of a direct-to-object inkjet printing system that may be used to carry out the present methods according to an illustrative embodiment.

FIG. 1B depicts a schematic of an illustrative controller of the direct-to-object inject printing system of FIG. 1A.

FIG. 1C depicts a flow diagram showing illustrative operations performed by the controller of FIG. 1B.

FIG. 2 is a plot of fluorescence emission versus degree of cure. The fluorescence emission was obtained from a dimer-forming fluorophore and is plotted in the form of I_{λm}/I_{Δd}, i.e., the intensity at the peak of a monomer fluorescence emission spectrum (λₘ)/the intensity at the peak of a dimer fluorescence emission spectrum (λ_{d}). The degree of cure was obtained using solvent extraction. The two curves correspond to two samples, each cured under different curing conditions.

### DETAILED DESCRIPTION

The present disclosure provides methods and systems for evaluating, in-situ, the degree of cure in ink compositions. In embodiments, the methods are faster and less complex than conventional techniques such as FTIR and solvent extraction. Moreover, the methods are non-destructive and minimize contact of cured films until the desired degree of cure is obtained. In addition, despite providing an indirect measurement of the degree of cure, the methods are both quantitative and accurate. In embodiments, the methods and systems may also be used for monitoring the performance of system components (e.g., lamps). Such monitoring may be used to initiate preventative maintenance measures, thereby minimizing system downtime.

A method for evaluating curing in an ink composition includes depositing an ink composition on a surface of an object via a direct-to-object inkjet printing system to form a film thereon. The ink composition comprises a photoinitiator capable of initiating a free radical polymerization process in the ink composition upon the absorption of light to cure the deposited film. The ink composition further comprises a fluorophore capable of emitting viscosity-dependent fluorescence upon the absorption of light. The method further comprises exposing, in-situ, the deposited film to a first source of light under conditions which initiate the free radical polymerization process to cure the deposited film. The method further comprises exposing the cured film to a second source of light under conditions which induce fluorescence emission by the fluorophore. The method further comprises measuring the fluorescence emission and determining a degree of cure in the cured film from the measured fluorescence emission and predetermined calibration data.

In the present disclosure, “in-situ” means that the referenced step is accomplished without removing the object from the direct-to-object inject printing system.

The method may be used to evaluate curing in a variety of ink compositions. In embodiments, the ink compositions comprise various combinations of acrylate oligomers and acrylate monomers. Illustrative acrylate oligomers include epoxy acrylates, aliphatic urethane acrylates, aromatic urethane acrylates, polyester acrylates, acrylic acrylates, etc. Acrylate monomers may be monofunctional or multifunctional (e.g., bifunctional, trifunctional, etc.). Illustrative acrylate monomers include isobornylacrylate, tripropylene glycol diacrylate, trimethylol propane triacrylate, hexanedioldiacrylate, di-trimethylolpropanetetra-acrylate, etc. In the present disclosure, the term “acrylate” also encompasses methacrylate. The ink compositions may also include various additives such as pigments (to impart color), fillers, defoamers, surface modifiers, etc. Additives also include dispersant and wetting additives such as silicone containing additives and polyacrylate based additives, rheological additives such as organoclay, diamide and polyester. Illustrative defoamers include modified polyols, polysiloxanes and dispersion of olefinic solids. The selection of these components and their relative amounts depends upon the desired properties for the cured film. One or more different ink compositions may be deposited in the methods in order to form the film on the object referenced above, e.g., individual ink compositions may form portions of the film which together form a complete film.

As noted above, the ink compositions also include a photoinitiator. The photoinitiator absorbs certain wavelengths of light to generate free radicals which react with components of the ink composition (e.g., the unsaturated double bonds in oligomers and monomers such as acrylate groups), as part of a free radical polymerization process to polymerize and crosslink, i.e., cure, the ink composition. Various types of photoinitiators and relative amounts may be used depending upon the desired properties for the cured film. Photoinitiators which generate free radicals by different processes may be used, e.g., Type I and Type II photoinitiators. Combinations of different types of photoinitiators may be used. Illustrative photoinitiators include methyl 2-benzyl benzonate, diphenyl(2,4,6-trimethylbenzoyl)phosphine oxide (TPO), 1-Hydroxycyclohexyl-1-phenyl methanone and 1-Butanone, 2-(dimethylamino)-2-(4-methylphenyl)methyl-1-4-(4-morpholinyl)phenyl-. Commercially available photoinitiators such as Irgacure 184 and Irgacure 379 may be used. The ink compositions may include more than one type of photoinitiator, e.g., two.

As noted above, the ink compositions also include a fluorophore. The fluorophore absorbs certain wavelengths of light which induces fluorescence emission by the fluorophore. Various types of fluorophores, e.g., organic dye molecules, may be used, provided the fluorophore is capable of emitting viscosity-dependent fluorescence. This means that the characteristics (e.g., intensity, wavelength, or both) of the fluorescence emission change due to changes in the viscosity of the medium (i.e., curing/cured film) containing the fluorophore. The viscosity of the medium is related to the degree of cure, i.e., an increase in viscosity corresponds to an increase in the degree of cure.

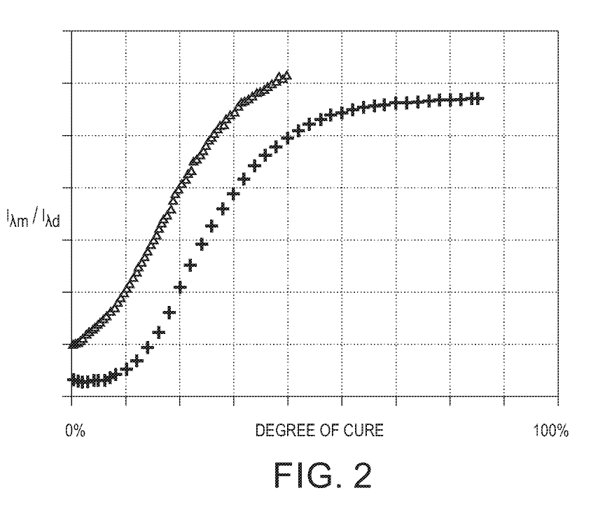

Fluorophores capable of forming dimers may be used. For dimer-forming fluorophores, the fluorophore in its monomer form and in its dimer form are characterized by different fluorescence emission spectra. The wavelength at the peak of the monomer fluorescence emission spectrum may be referred to as λₘ and the wavelength at the peak of the dimer fluorescence emission spectrum may be referred to as λ_{d}. For dimer-forming fluorophores, λₘ and λ_{d} are different. The fluorescence emission of dimer-forming fluorophores changes as a function of viscosity since the viscosity changes the ratio of monomer/dimer in the medium. Such fluorescence emission changes may be monitored via the ratio of the fluorescence emission intensity at λₘ, and λ_{d}, i.e., I_{λm}/I_{λd}. An increase in the ratio I_{λm}/I_{λd} corresponds to an increase in viscosity and thus, to an increase in the degree of cure. (See FIG. 2.) Illustrative dimer-forming fluorophores include pyrene and certain pyrene derivatives. Other illustrative fluorophores include those which exhibit a decrease in fluorescence emission intensity as viscosity increases (e.g., due to quenching). Illustrative such fluorophores include 1,3-bis-(1-pyrene) propane.

Other illustrative fluorophores include rhodamine, coumarin, cyanin, squarnine, oxazine derivatives like Nile red, Nile blue, auramarine, phthaloxyanine and bilirubin.

Various amounts of fluorophore may be used in the ink compositions, provided the amount does not materially affect the curing process of the ink composition. Illustrative amounts include those in the range of from about 10⁻⁵ to about 10⁻⁶ M.

In embodiments, the ink composition includes 1-[4-(Dimethylamino)phenyl]-6-phenylhexatriene (DMA-DPH). This compound may be useful to increase the response (sensitivity) of the cure measurement.

As noted above, the methods may be carried out on a direct-to-object inkjet printing system. The direct-to-object inkjet printing system is configured to apply image content (e.g., pictures, words, numbers, etc.) to the surfaces of a variety of objects. Illustrative objects include commercial articles such as sports equipment (e.g., football helmets, golf clubs, soccer balls, etc.), clothing (e.g., hats, T-shirts, jackets, etc.), containers (e.g., travel mugs, water bottles, etc.), etc. Objects to be printed may be finished, post-manufactured products, i.e., as opposed to the raw materials used to manufacture the objects. The direct-to-object inkjet printing system may be used to apply image content to objects in a non-production environment (e.g., a distribution site) for customizing the objects prior to sale or distribution.

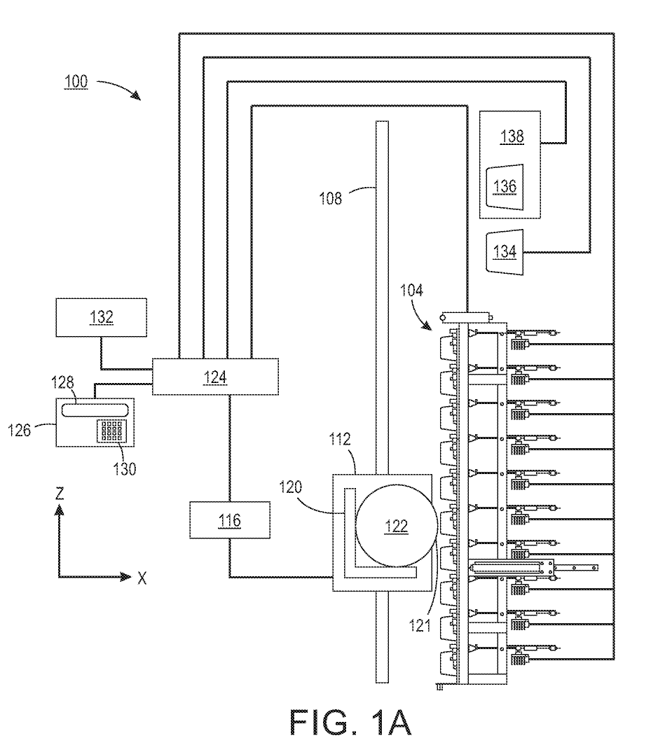

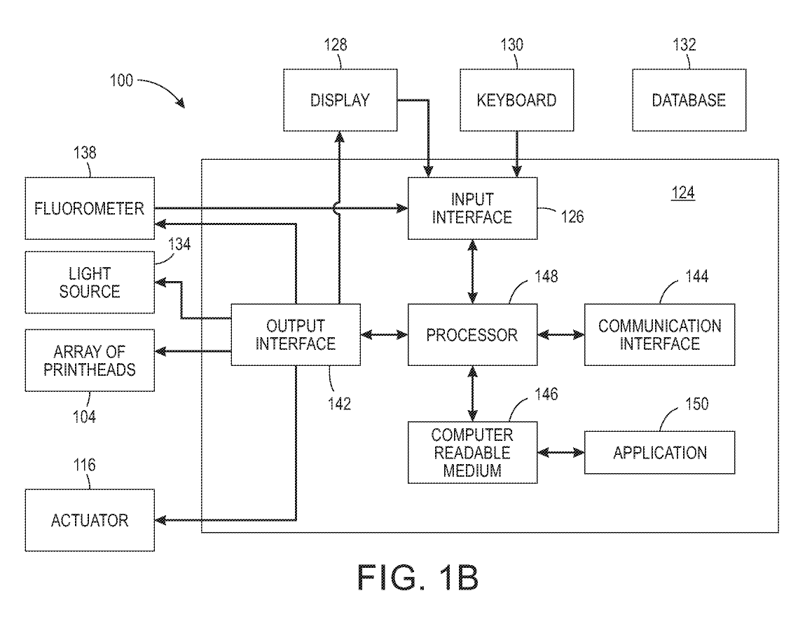

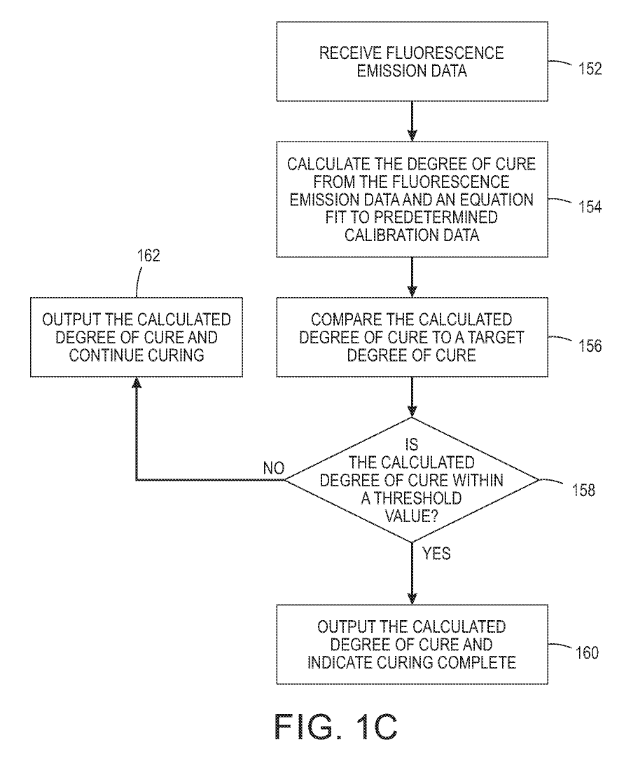

A schematic of an illustrative direct-to-object inkjet printing system 100 which may be used to carry out the present methods is shown in FIG. 1A. The printing system 100 includes a vertically oriented array of printheads 104, a support member 108, a member 112 movably mounted to the support member 108, an actuator 116 operatively connected to the movably mounted member 112, an object holder 120 configured to mount to the movably mounted member 112 and to hold an object 122, and a controller 124 operatively connected to the array of printheads 104 and the actuator 116. As shown in FIG. 1A, the array of printheads 104 is a 10×1 linear array (i.e., 10 printheads), although other array configurations can be used. Each printhead is fluidly connected to a supply of an ink composition (not shown) and is configured to eject the ink composition onto a surface 121 of the object 122. Some of the printheads can be connected to the same supply or each printhead can be connected to its own supply so each printhead can eject a different ink composition.

The support member 108 is positioned parallel to a line (or plane) formed by the array of printheads 104 (i.e., parallel to the z-axis or parallel to the yz plane, the y axis projects out of the plane of the paper of FIG. 1A). The member 112 is movably mounted to the support member 108 to enable the member 112 to slide along the support member 108. In some embodiments, the member 112 can move bi-directionally along the support member 108 (i.e., in the +z direction and the −z direction). The actuator 116 is operatively connected to the movably mounted member 112 so the actuator 116 can move the moveably mounted member 112 along the support member 108 and enable the object holder 120 mounted to the moveably mounted member 112 (as well as the object 122) to pass the array of printheads 104 in one dimension. In the embodiment depicted in FIG. 1A, the movably mounted member 112 moves the object 122 along the z axis while the array of printheads 104 remains stationary.

The controller 124 controls the operation of various components of the printing system 100. As shown in FIG. 1B, the controller 124 may include various interfaces (e.g., input interface 126, output interface 142, communication interface 144, and combinations thereof), a computer-readable medium 146, a processor 148, and a control application 150. By way of illustration, the input interface 126 may interface with various input technologies such as a display 128, a keypad 130, etc. to allow a user to enter information into controller 124 or to make selections from options shown on the display 128.

The processor 148 of the controller 124 executes instructions, meaning that it performs/controls the operations called for by that instruction. The processor 148 may be implemented in hardware, firmware, or any combination of these methods and/or in combination with software. The processor 148 operably couples with input interface 126, with output interface 142, with computer-readable medium 146, and with communication interface 144 to receive, to send, and to process information.

The control application 150 performs operations associated with controlling the operation of the printing system 100. The operations may be implemented using hardware, firmware, software, or any combination of these methods. As shown in FIG. 1C, the control application 150 may be implemented in software (comprised of computer-readable and/or computer-executable instructions) stored in the computer-readable medium 146 and accessible by the processor 148 for execution of the instructions that embody the operations of the control application 150. In this way, the controller 124 may be configured to operate the actuator 116 to move the object holder 120 (and the object 122 mounted thereon) past the array of printheads 104. The controller 124 may also be configured to operate the array of printheads 104 to eject the ink composition onto the surface 121 of the object 122 as the object holder 120 passes the array of printheads 104. Other illustrative operations which may be associated with control application 150 are shown in FIG. 1C, and are further described below.

Other details of the printing system 100 and other illustrative direct-to-object printing systems may be found in U.S. application Ser. No. 15/163,880, which is hereby incorporated by reference in its entirety.

The printing system 100 further includes a first light source 134, the operation of which may also be controlled by controller 124. The controller 124 may be configured to operate the actuator 116 to move the object holder 120 (and the object 122 mounted thereon) to a position in front of the first light source 134. Once in position (or while the object holder 120 is moving past the first light source 134), a film of deposited ink composition on the surface 121 of the object 122 can be exposed to light generated by the first light source 134 upon a signal from the controller 124.

The first light source 134 is configured to induce curing in the deposited film. This means that the deposited film is exposed to light from the first light source 134 under conditions which initiate the free radical polymerization process to cure the deposited film. These conditions can refer to the wavelength and intensity of the light generated by the first light source 134. Selection of the wavelength and intensity can depend in part, upon the components of the ink composition including the photoinitiator. Other considerations which may guide selection include the presence of pigments in the ink composition as well as the thickness of the deposited film (e.g., greater intensities may be used in the presence of pigments and/or with thicker films). In general, however, the wavelength and intensity are selected to initiate the free radical polymerization process in the deposited film as described above. Wavelength and intensity may also be adjusted to optimize curing. In embodiments, the wavelength is selected such that it substantially overlaps an absorption maximum (λₘₐₓ) of the photoinitiator. The term “substantially” means that the selected wavelength is within at least ±10% of the λₘₐₓ of the photoinitiator. Similarly, for a particular first light source 134 having a predetermined wavelength and intensity, the photoinitiator may also be selected by following these same guidelines.

In embodiments, the light generated by the first light source 134 is in the ultraviolet (UV) to visible portion of the electromagnetic spectrum, e.g., comprising a wavelength in the range of from about 200 nm to about 450 nm. In embodiments, the light comprises a wavelength in the range of from about 340 nm to about 420 nm, from about 350 nm to about 410 nm, or from about 360 nm to about 405 nm. In embodiments, the light comprises a wavelength of about 395 nm. Various light sources may be used for the first light source 134. In embodiments, the light source is a light-emitting diode (LED). LED light sources are characterized by fairly narrow spectral widths, e.g., about 50 nm, about 100 nm, or about 150 nm. However, broad spectrum light sources may be used, such lamps, including an iron doped mercury vapor lamp.

The conditions sufficient to initiate the free radical polymerization process to cure the deposited film and to optimize curing can also include the length of time the deposited film is exposed to light generated by the first light source 134.

Curing may also be accomplished using two light sources instead of the single light source 134 shown in FIG. 1A. Two light sources may be useful for bulk and surface curing of the deposited film.

The printing system 100 further includes a second light source 136, the operation of which may also be controlled by the controller 124. The controller 124 may be configured to operate the actuator 116 to move the object holder 120 (and the object 122 mounted thereon) to a position in front of the second light source 136. Once in position (or while the object holder 120 is moving past the second light source 136), the cured film on the surface 121 of the object 122 can be exposed to light generated by the second light source 136 upon a signal from the controller 124.

The second light source 136 is configured to induce fluorescence emission by the fluorophore in the cured film after a curing step. This means that the cured film is exposed to light from the second light source 136 under conditions sufficient to induce light absorption by the fluorophore, and thus, subsequent fluorescence emission. These conditions can refer to the wavelength and intensity of the light generated by the second light source 136. Selection of the wavelength and intensity can depend, in part, upon the choice of fluorophore. Similar to the photoinitiator as described above, the wavelength may be selected such that it substantially overlaps an absorption maximum of the fluorophore. The term “substantially” has a meaning analogous to the meaning as described above with respect to the photoinitiator. However, the wavelength and/or intensity of the light generated by second light source 136 may be selected to minimize or prevent generation of photoinitiator free radicals so as to minimize or prevent further curing by the second light source 136. This may be accomplished by selecting a fluorophore having an absorption maximum which is sufficiently separated from the absorption maximum of the photoinitiator. Alternatively, or in addition, the intensity of the second light source 136 or length of time the cured film is exposed to the second light source 136 or both may be limited so as to minimize or prevent further curing.

In embodiments, the light generated by the second light source 136 is in the ultraviolet (UV) to visible portion of the electromagnetic spectrum, e.g., comprising a wavelength in the range of from about 200 nm to about 800 nm. In embodiments, the light comprises a wavelength in the range of from about 250 nm to about 750 nm, from about 400 nm to about 800 nm, or from about 400 nm to about 600 nm. Various light sources may be used for the second light source 136.

As shown in FIG. 1A, the second light source 136 may be part of a fluorometer 138 which may be operatively connected to the controller 124. The fluorometer 138 may include components typically found in fluorometers, e.g., monochromator, optics for directing light, detector, and/or a controller (i.e., distinct from controller 124). After the cured film is exposed to light from the second light source 136, the fluorescence emission from the surface of the cured film is detected. The intensity of the fluorescence emission may be measured at one wavelength (e.g., at the expected peak of the fluorescence emission spectrum) or at multiple wavelengths (e.g., at the expected peaks of a monomer fluorescence emission spectrum, λₘ and a dimer fluorescence emission spectrum, λ_{d}). As noted above, the fluorescence emission intensities are related to the viscosity of the curing/cured film and the viscosity is related to the degree of cure in the film. The phrase “measuring fluorescence emission” encompasses measuring the intensity of fluorescence emission at a particular wavelength as well as determining I_{λm}/I_{λd}. Such a determination may be carried out by a controller operatively connected to the fluorometer 138, including controller 124, e.g., via operations associated with control application 150.

Quantifying the degree of cure in a cured film having an unknown degree of cure is carried out by comparing the measured fluorescence to predetermined calibration data. The predetermined calibration data relates fluorescence emission to a different, predetermined measurement of the degree of cure of a control ink composition. The different, predetermined measurement of degree of cure may be one derived from a conventional technique for measuring degree of cure, such as solvent extraction. Using solvent extraction, a cured film is exposed to a solvent and the amount of material dissolved in the solvent is measured. The dissolved material primarily includes unreacted components such as monomers. The amount of dissolved material measured can be compared to the amount of dissolved material measured from a control film which has been fully cured. This ratio (or percentage) is equivalent to the degree of cure.

To generate predetermined calibration data which relates fluorescence emission to the degree of cure via solvent extraction, a series of films formed from a control ink composition, each film in the series having a different, but known degree of cure as measured using solvent extraction are prepared. Next, a fluorescence emission measurement is made for each of these films as described above. The result is predetermined calibration data comprising a set of predetermined fluorescence emission values and associated predetermined degree of cure values. FIG. 2 shows illustrative predetermined calibration data obtained as described above. The fluorescence emission values are for a dimer-forming fluorophore and are plotted in the form of I_{λm}/I_{λd}. The two curves correspond to two separate samples cured under different curing conditions. The degree of cure values are those obtained using solvent extraction. The predetermined calibration data may also be plotted and a fit to an equation. The equation can be used to calculate the degree of cure from the measured fluorescence emission from a cured film having an unknown degree of cure. The control ink composition used to generate the predetermined calibration data may be an ink composition which is the same or substantially the same as used to prepare the cured film having the unknown degree of cure. The term “substantially” is used in recognition of the fact that the two ink compositions may not be identical but the differences do not result in material differences in the curing of the two ink compositions.

Determination of the degree of cure in a cured film having an unknown degree of cure may be carried out using a processor, e.g., the processor 148 of the controller 124. This includes fitting the predetermined calibration data to the equation, calculating the degree of cure from the measured fluorescence emission and the equation, or both. The determination may be output to the display 126. The predetermined calibration data may be stored in a memory accessible by the processor 148 or a database 132 accessible by the processor 148.

Once the degree of cure is determined, a decision may be made as to whether an additional curing step using the first source of light 134 is desirable or not. Additional determinations of the degree of cure and additional curing may be carried out until a target degree of cure is obtained. A determination as to whether additional curing steps should be carried out may also be accomplished using the processor 148 of the controller 124. By way of illustration, the calculated degree of cure may be compared to a predetermined target degree of cure. If the calculated degree of cure is outside of a predetermined threshold value, e.g., outside ±10%, ±5%, ±2%, etc. of the target degree of cure, then one or more additional curing steps may be carried out. In addition, one or more of the curing conditions may be adjusted in order to optimize curing. If the calculated degree of cure is within the predetermined threshold value, the curing may be considered to be complete.

Some of the operations which may be associated with control application 150 are illustrated in FIG. 1C. In an operation 152, fluorescence emission data are received for processing by the processor 148. This data may include raw intensity data, e.g., from a detector of the fluorometer 138. Such raw intensity data may be subsequently processed by processor 148 to provide I_{λm}/I_{λd} data as described above. Next, in operation 154, the degree of cure may be calculated from the fluorescence emission data and an equation fit to predetermined calibration data. This predetermined calibration data may be read from the computer-readable medium 146 or the database 132. The fitting of the equation to the predetermined calibration data may also be carried out by the processor 148. Next, in operation 156, the calculated degree of cure can be compared with the target degree of cure, which may have been input by a user via the input interface 126. Next, in operation 158, a determination is made concerning whether or not the calculated degree of cure is within the predetermined threshold value. If the calculated degree of cure is within the predetermined threshold value, then in operation 160, the calculated degree of cure may be output, e.g., to the display 128, in the form of an indication that curing is complete. If the calculated degree of cure is outside the predetermined threshold value, then in operation 162, the calculated degree of cure may be output, e.g., via the output interface 142, in the form of a signal to the relevant components of the direct-to-object printing system 100 to continue curing.

FIG. 1A shows the direct-to-object printing system 100 which includes the second light source 136, enabling in-situ exposure to light from the second light source 136, measurement of fluorescence emission, and determination of degree of cure. Alternatively, the printing system 100 need not include the second light source. Instead, ex-situ exposure, measurement and determination may also be used, e.g., via a hand-held, portable fluorometer. After such evaluation, the object may be reloaded onto the printing system for additional curing steps, if desired.

In embodiments, the methods and systems may also be used for monitoring the performance of system components. By way of illustration, an unexpected calculated degree of cure (e.g., one which is lower than expected based on curing conditions otherwise known to provide the target degree of cure) may be an indication that certain system components require maintenance, repair, or replacement. This may happen, for example, when light output diminishes over time due to the aging of the first light source 134. With reference to FIG. 1C, the control application 150 may be configured to monitor the performance of system components and even initiate preventative maintenance measures. By way of illustration, in operation 162, the calculated degree of cure may be output, e.g., to the display 128, in the form of an indication to perform a maintenance check on one or more system components. Alternatively, or in addition, the calculated degree of cure may be output via the output interface 142 in the form of a signal to initiate such maintenance checks. The maintenance check may be measuring the intensity of the first light source 134. If the result of the maintenance check is diminished lamp output, for example, the control application 150 may be further configured to increase power to the lamp to increase its intensity, prior to carrying out any additional curing.

The methods may be carried out on other types of inkjet printing systems, e.g., three-dimensional printing systems.

Also provided are systems for carrying out the methods. The illustrative printing system 100 of FIG. 1A is an example.

As used throughout the present disclosure, unless otherwise indicated, parts and percentages are by weight. As used throughout the present disclosure, “room temperature” refers to a temperature of from about 20° C. to about 25° C.

As throughout the present disclosure, the term “mount” and similar terms encompass direct mounting (in which the referenced elements are in direct contact) and indirect mounting (in which the referenced elements are not in direct contact, but are connected through an intermediate element). Elements referenced as mounted to each other herein may further be integrally formed together. As a result, elements described herein as being mounted to each other need not be discrete structural elements. The elements may be mounted permanently, removably, or releasably unless specified otherwise.

In addition, use of directional terms, such as top, bottom, right, left, front, back, upper, lower, etc. are merely intended to facilitate reference to various surfaces that form components of the devices referenced herein and are not intended to be limiting in any manner.

It will be appreciated that variants of the above-disclosed and other features and functions or alternatives thereof, may be combined into many other different systems or applications. Various presently unforeseen or unanticipated alternatives, modifications, variations or improvements therein may be subsequently made by those skilled in the art, which are also intended to be encompassed by the following claims.

What is claimed is:

1. A method for evaluating curing in an ink composition, the method comprising:
(a) depositing an ink composition on the surface of an object via a direct-to-object inkjet printing system to form a film thereon, the ink composition comprising a photoinitiator capable of initiating a free radical polymerization process in the ink composition upon the absorption of light to cure the deposited film and a fluorophore capable of emitting viscosity-dependent fluorescence upon the absorption of light;
(b) exposing, in-situ, the deposited film to light generated by a first source of light under conditions which initiate the free radical polymerization process to cure the deposited film;
(c) exposing the cured film to light generated by a second source of light under conditions which induce fluorescence emission by the fluorophore in the cured film;
(d) measuring the fluorescence emission; and
(e) determining a degree of cure in the cured film from the measured fluorescence emission and predetermined calibration data.

2. The method of claim 1, wherein the exposing in step (c) is accomplished in-situ.

3. The method of claim 1, wherein the object is a finished, post-manufactured commercial article.

4. The method of claim 1, wherein the ink composition further comprises one or more types of acrylate oligomers, one or more types of acrylate monomers, and a pigment.

5. The method of claim 1, wherein the fluorophore is a dimer-forming fluorophore, wherein the fluorescence emission of the fluorophore in its monomer form is characterized by a peak at λₘ and the fluorescence emission of the fluorophore is its dimer form is characterized by a peak at λ_{d}.

6. The method of claim 5, wherein measuring the fluorescence emission comprises determining a ratio of the intensity at λₘ, (I_{λm}) to the intensity at λ_{d} (I_{λd}).

7. The method of claim 1, wherein the fluorophore is selected from pyrene and 1,3-bis-(1-pyrene) propane.

8. The method of claim 1, wherein the predetermined calibration data comprises a set of predetermined fluorescence emission values and associated predetermined degree of cure values, the predetermined degree of cure values generated using solvent extraction.

9. The method of claim 1, wherein the predetermined calibration data is fit to an equation and the degree of cure is calculated using the measured fluorescence emission and the equation.

10. The method of claim 1, further comprising repeating step (b) one or more times to further cure the cured film until a predetermined target degree of cure is achieved.

11. The method of claim 1, wherein the direct-to-object printing system comprises:
an array of printheads, the array comprising one printhead configured to eject the ink composition and one or more additional printheads configured to eject one or more additional ink compositions;
a support member positioned parallel to the array of printheads;
an object holder configured to hold the object such that the surface of the object faces towards the array of printheads, the object holder moveably mounted to the support member;
the first source of light;
the second source of light;
an actuator operatively connected to the object holder to move the object holder relative to the array of printheads, the first source of light, and second source of light; and
a controller operatively connected to the array of printheads, the actuator, the first source of light, and the second source of light, the controller configured to operate the array of printheads, the actuator, the first source of light, and the second source of light.

12. The method of claim 11, wherein the second source of light is part of a fluorometer operatively connected to the controller.

13. The method of claim 11, wherein the controller comprises a processor and a non-transitory computer-readable medium comprising instructions that, when executed by the processor, cause the controller to calculate the degree of cure using the measured fluorescence emission and an equation fit to the predetermined calibration data.

14. The method of claim 13, wherein the instructions, when executed by the processor, further cause the controller to compare the calculated degree of cure to a predetermined target degree of cure and to carry out step (b) an additional time if the calculated degree of cure is outside a predetermined threshold value.

15. The method of claim 13, wherein the instructions, when executed by the processor, further cause the controller to compare the calculated degree of cure to a predetermined target degree of cure and to indicate that a maintenance check is required if the calculated degree of cure is outside a predetermined threshold value.

16. The method of claim 15, wherein the instructions, when executed by the processor, further cause the controller to carry out the maintenance check.

17. A direct-to-object printing system comprising:
an array of printheads, the array comprising one printhead configured to eject an ink composition and one or more additional printheads configured to eject one or more additional ink compositions;
a support member positioned parallel to the array of printheads;
an object holder configured to hold an object such that the surface of the object faces towards the array of printheads, the object holder moveably mounted to the support member;
a first source of light;
a second source of light;
an actuator operatively connected to the object holder to move the object holder relative to the array of printheads, the first source of light, and second source of light; and
a controller operatively connected to the array of printheads, the actuator, the first source of light, and the second source of light, the controller configured to operate the direct-to-object printing system to
(a) deposit the ink composition on the surface of the object to form a film thereon, the ink composition comprising a photoinitiator capable of initiating a free radical polymerization process in the ink composition upon the absorption of light to cure the deposited film and a fluorophore capable of emitting viscosity-dependent fluorescence upon the absorption of light;
(b) expose, in-situ, the deposited film to light generated by the first source of light under conditions which initiate the free radical polymerization process to cure the deposited film;
(c) expose, in-situ, the cured film to light generated by the second source of light under conditions which induce fluorescence emission by the fluorophore in the cured film;
(d) measure the fluorescence emission; and
(e) determine a degree of cure in the cured film from the measured fluorescence and predetermined calibration data.

18. The method of claim 17, wherein the second light source is part of a fluorometer operatively connected to the controller.

19. The method of claim 17, wherein the controller comprises a processor and a non-transitory computer-readable medium comprising instructions that, when executed by the processor, cause the controller to calculate the degree of cure using the measured fluorescence emission and an equation fit to the predetermined calibration data.

20. The method of claim 19, wherein the instructions, when executed by the processor, further cause the controller to compare the calculated degree of cure to a predetermined target degree of cure and to carry out step (b) an additional time if the calculated degree of cure is outside a predetermined threshold value.
